(19) United States
(12) Patent Application Publication
(10) Pub. No.: US 2020/0247404 A1
(43) Pub. Date: Aug. 6, 2020

(54) INFORMATION PROCESSING DEVICE, INFORMATION PROCESSING SYSTEM, INFORMATION PROCESSING METHOD, AND PROGRAM

(71) Applicant: TOYOTA JIDOSHA KABUSHIKI KAISHA, Toyota-shi (JP)

(72) Inventors: Yoshihiro Ohe, Kawasaki-shi (JP); Ayana Takeshita, Kasugai-shi (JP); Shunsuke Tanimori, Susono-shi (JP); Ryosuke Tanimura, Nisshin-shi (JP); Yuhei Suzuki, Kariya-shi (JP); Hiromitsu Fujii, Kariya-shi (JP)

(73) Assignee: TOYOTA JIDOSHA KABUSHIKI KAISHA, Toyota-shi (JP)

(21) Appl. No.: 16/748,837

(22) Filed: Jan. 22, 2020

(30) Foreign Application Priority Data
Feb. 1, 2019 (JP) 2019-017365

(51) Int. Cl. B60W 30/095; G06K 9/00; G08G 1/01; G08G 1/16

(52) U.S. Cl. CPC B60W 30/0956; G06K 9/00825; G08G 1/0112; B60W 2554/4046; B60W 2400/00; B60W 2420/42; G08G 1/166

(57) ABSTRACT

An information processing device includes a control unit configured to acquire vehicle identification information for identifying another vehicle included in a surrounding image of a vehicle which is captured by an imaging unit based on the surrounding image and to evaluate a driving risk level of the other vehicle based on a traveling state of the other vehicle and a communication unit configured to transmit dangerous vehicle information including the vehicle identification information and the driving risk level of the other vehicle to a database outside the vehicle.

### INCORPORATION BY REFERENCE

The disclosure of Japanese Patent Application No. 2019-017365 filed on Feb. 1, 2019 including the specification, drawings and abstract is incorporated herein by reference in its entirety.

### BACKGROUND

### 1. Technical Field

The disclosure relates to an information processing device, an information processing system, an information processing method, and a program.

### 2. Description of Related Art

In the related art, a technique of acquiring information on a dangerous vehicle which is driven in a dangerous manner from an image captured by a camera is known. For example, Japanese Patent Application Publication No. 2016-130935 (JP 2016-130935 A) discloses a technique of detecting a vehicle which has violated traffic rules based on an image captured by a camera which is provided in a specific place such as a crossing.

### SUMMARY

In the related art, an area in which information on a dangerous vehicle can be acquired is limited to the vicinity of a specific place in which a camera is provided.

The disclosure provides an information processing device, an information processing system, an information processing method, and a program that can acquire information on a vehicle which is driven in a dangerous manner in a broader area.

According to an aspect of the disclosure, there is provided an information processing device that is mounted in a vehicle including an imaging unit, the information processing device including: a control unit configured to acquire vehicle identification information for identifying another vehicle included in a surrounding image of the vehicle which is captured by the imaging unit based on the surrounding image and to evaluate a driving risk level of the other vehicle based on a traveling state of the other vehicle; and a communication unit configured to transmit dangerous vehicle information including the vehicle identification information and the driving risk level of the other vehicle to a database outside the vehicle.

According to another aspect of the disclosure, there is provided an information processing system including: an information processing device that is mounted in a vehicle including an imaging unit; a database that is located outside the vehicle; and an analysis device. The information processing device acquires vehicle identification information for identifying another vehicle included in a surrounding image of the vehicle which is captured by the imaging unit based on the surrounding image, evaluates a driving risk level of the other vehicle based on a traveling state of the other vehicle, and transmits dangerous vehicle information including the vehicle identification information and the driving risk level of the other vehicle to the database. The analysis device identifies a dangerous vehicle which is driven in a dangerous manner based on the dangerous vehicle information stored in the database and transmits information on the identified dangerous vehicle to a predetermined destination.

According to still another aspect of the disclosure, there is provided an information processing method which is performed by an information processing device that is mounted in a vehicle including an imaging unit, the information processing method including: a step of acquiring vehicle identification information for identifying another vehicle included in a surrounding image of the vehicle which is captured by the imaging unit based on the surrounding image and evaluating a driving risk level of the other vehicle based on a traveling state of the other vehicle; and a step of transmitting dangerous vehicle information including the vehicle identification information and the driving risk level of the other vehicle to a database outside the vehicle.

According to still another aspect of the disclosure, there is provided a program causing an information processing device that is mounted in a vehicle including an imaging unit to perform: a step of acquiring vehicle identification information for identifying another vehicle included in a surrounding image of the vehicle which is captured by the imaging unit based on the surrounding image and evaluating a driving risk level of the other vehicle based on a traveling state of the other vehicle; and a step of transmitting dangerous vehicle information including the vehicle identification information and the driving risk level of the other vehicle to a database outside the vehicle.

With the information processing device, the information processing system, the information processing method, and the program according to the disclosure, it is possible to acquire information on a vehicle which is driven in a dangerous manner in a broader area.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating an example of a configuration of an information processing system including an information processing device according to an embodiment of the disclosure;

FIG. 2 is a flowchart illustrating an example of an operation of the information processing device illustrated in FIG. 1; and

FIG. 3 is a sequence diagram illustrating an example of an operation of the information processing system illustrated in FIG. 1.

### DETAILED DESCRIPTION OF EMBODIMENTS

Hereinafter, an embodiment of the disclosure will be described with reference to the accompanying drawings. In the drawings, the same reference signs refer to the same or equivalent elements.

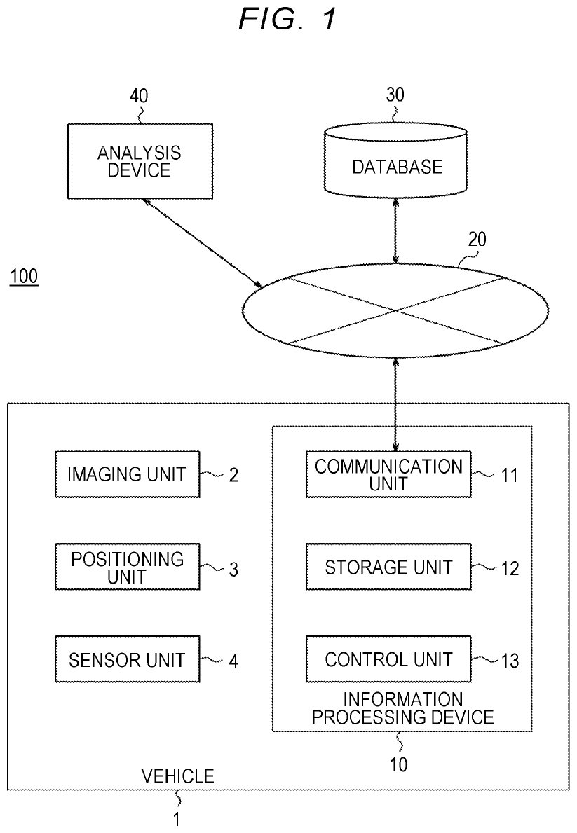

FIG. 1 is a diagram illustrating an example of a configuration of an information processing system 100 including an information processing device 10 according to an embodiment of the disclosure. The information processing system 100 includes an information processing device 10 which is mounted in a vehicle 1, a database 30, and an analysis device 40.

The information processing device 10 according to this embodiment acquires vehicle identification information for identifying another vehicle included in a surrounding image of the vehicle 1 based on the image which is acquired by imaging the surroundings of the vehicle 1 and evaluates a driving risk level of the other vehicle based on a traveling state of the other vehicle. The information processing device 10 transmits dangerous vehicle information including the vehicle identification information and the driving risk level of the other vehicle to a database 30 outside the vehicle 1 via a network 20 including a mobile communication network or the Internet. In FIG. 1, one vehicle 1 is illustrated for the purpose of simplification, but dangerous vehicle information is transmitted from the information processing devices 10 mounted in a plurality of vehicles 1 to the database 30.

The database 30 stores the dangerous vehicle information transmitted from the information processing device 10. The database 30 may have any configuration as long as it has a function of communicating via the network 20 and a function of storing information. Accordingly, details of the configuration of the database 30 will not be described.

The analysis device 40 accesses the database 30 via the network 20, analyzes the dangerous vehicle information stored in the database 30, and performs various processes. For example, the analysis device 40 identifies a dangerous vehicle which is driven in a dangerous manner based on the dangerous vehicle information stored in the database 30 and transmits information on the dangerous vehicle to a predetermined destination. For example, the analysis device 40 transmits information on the dangerous vehicle to the other vehicle in a predetermined area. The analysis device 40 transmits information on the dangerous vehicle to, for example, a predetermined organization that executes traffic enforcement. When information on a position of a dangerous vehicle can be acquired, the analysis device 40 may predict a traveling direction of the dangerous vehicle based on the position of the dangerous vehicle and transmit the information on the dangerous vehicle to a vehicle which is in the predicted traveling direction. The analysis device 40 may have any configuration as long as it has a function of communicating via the network 20 and a function of analyzing information stored in the database 30 and performing various processes. Accordingly, details of the configuration of the analysis device 40 will not be described.

The database 30 and the analysis device 40 may be integrally configured as a single module.

The schematic configuration of the vehicle 1 will be described below.

The vehicle 1 includes an imaging unit 2, a positioning unit 3, a sensor unit 4, and an information processing device 10.

The imaging unit 2 includes an onboard camera which generates an image by imaging a subject in a field of view. The onboard camera may be a monocular camera or a stereoscopic camera. The imaging unit 2 is provided in the vehicle 1 such that it can image the surroundings of the vehicle 1. For example, an electronic device having a camera function such as a drive recorder or a smartphone which is carried by an occupant may serve as the imaging unit 2.

The positioning unit 3 includes a receiver corresponding to a satellite positioning system. The receiver supports, for example, the Global Positioning System (GPS), but is not limited thereto and may support an arbitrary satellite positioning system. For example, a car navigation device may serve as the positioning unit 3. The positioning unit 3 acquires position information of the vehicle 1 in which the information processing device 10 is mounted.

The sensor unit 4 includes an onboard sensor that detects a state of an object (such as a pedestrian or another vehicle) near the vehicle 1. The sensor unit 4 includes, for example, a distance sensor and a speed sensor, but is not limited thereto.

The configuration of the information processing device 10 will be described below.

The information processing device 10 illustrated in FIG. 1 includes a communication unit 11, a storage unit 12, and a control unit 13.

The communication unit 11 includes a communication module that is connected to the network 20. The communication module supports a mobile communication standard such as 4th generation (4G) or 5th generation (5G), but is not limited thereto and may support an arbitrary communication standard. For example, an onboard communication device such as a data communication module (DCM) may serve as the communication unit 11. In this embodiment, the information processing device 10 is connected to the network 20 via the communication unit 11.

The storage unit 12 includes one or more memories. In this embodiment, a “memory” is, for example, a semiconductor memory, a magnetic memory, or an optical memory, but is not limited thereto. Each memory included in the storage unit 12 may serve as, for example, a main storage device, an auxiliary storage device, or a cache storage device. The storage unit 12 stores arbitrary information which is used for operation of the information processing device 10. For example, the storage unit 12 stores information such as a reference for evaluating a driving risk level of the other vehicle. The storage unit 12 may store, for example, a system program, an application program, and embedded software.

The control unit 13 includes one or more processors. In this embodiment, a “processor” is a general-purpose processor or a dedicated processor that specializes in a specific process, but is not limited thereto. For example, an electronic control unit (ECU) which is mounted in the vehicle 1 may serve as the control unit 13. The control unit 13 controls the entire operation of the information processing device 10.

For example, the control unit 13 acquires a surrounding image of the vehicle 1 which is captured by the imaging unit 2. The control unit 13 acquires vehicle identification information for identifying the other vehicle included in the acquired image based on the image. The control unit 13 evaluates a driving risk level of the other vehicle based on a traveling state of the other vehicle. The control unit 13 causes the communication unit 11 to transmit dangerous vehicle information including vehicle identification information and a driving risk level of the other vehicle to the database 30 via the network 20.

The operation of the information processing device 10 according to this embodiment will be described below.

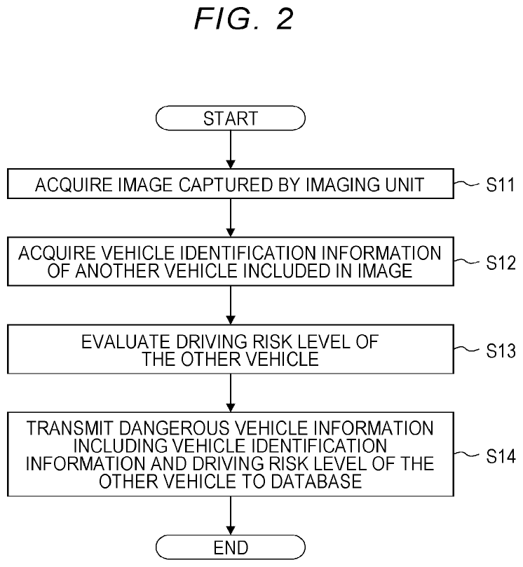

FIG. 2 is a diagram illustrating an example of the operation of the information processing device 10 according to this embodiment and is a diagram illustrating an information processing method which is performed by the information processing device 10. In FIG. 2, the operation of the control unit 13 will be mainly described.

The control unit 13 acquires a surrounding image of the vehicle 1 which is captured by the imaging unit 2 (Step S11).

Then, the control unit 13 acquires vehicle identification information for identifying the other vehicle included in the acquired image based on the image (Step S12). The control unit 13 acquires, for example, information on at least one of a number, a model number, a color, and a type (such as a sedan type or a box type) of the other vehicle as the vehicle identification information. The control unit 13 can acquire the vehicle identification information by performing various image recognition processes on the image acquired from the imaging unit 2.

As described above, dangerous vehicle information including the vehicle identification information and the driving risk level of the other vehicle is stored in the database 30. Then, the analysis device 40 identifies a dangerous vehicle based on the dangerous vehicle information stored in the database 30 and transmits information on the dangerous vehicle to a predetermined destination. Information such as a vehicle model, a color, or a type of a vehicle is not information for uniquely identifying a vehicle unlike a vehicle number of a vehicle. However, in the above-mentioned transmission of information, attention can be called to the other vehicle or the like by only transmitting a vehicle module, a color, or a type of a dangerous vehicle. Accordingly, it is advantageous that information such as a vehicle module, a color, or a type of the other vehicle be acquired as vehicle identification information. The information which is acquired as the vehicle identification information is not limited to the above examples and may be arbitrary information for ascertaining features of the other vehicle.

The control unit 13 estimates a traveling state of the other vehicle of which the vehicle identification information has been acquired. The control unit 13 estimates a speed of the other vehicle, a distance from the other vehicle, and the like as a traveling state of the other vehicle, for example, based on a result of detection from the sensor unit 4. In order to estimate a traveling state of the other vehicle included in the image captured by the imaging unit 2 based on the result of detection from the sensor unit 4, correlation between a detection object of the sensor unit 4 and the other vehicle included in the image captured by the imaging unit 2 needs to be performed. For example, the control unit 13 estimates a distance from the other vehicle included in the image captured by the imaging unit 2 based on the image and identifies an object close to the distance estimated based on the image captured by the imaging unit 2 out of objects from which a distance has been detected by a distance sensor as the other vehicle. In general, imaging conditions (such as an angle of view and a magnification) of the imaging unit 2 are known. Accordingly, the control unit 13 can estimate a distance from the other vehicle based on the imaging conditions of the imaging unit 2 and the position and the size of the other vehicle in the image captured by the imaging unit 2.

The control unit 13 may estimate a traveling state of the other vehicle based on the image captured by the imaging unit 2. For example, the control unit 13 can estimate a braking frequency (the number of times a brake lamp is turned on) as the traveling state of the other vehicle based on the image captured by the imaging unit 2. The control unit 13 can estimate violation of a traffic signal, violation of temporary stop, traveling over a plurality of lanes, and the like as the traveling state of the other vehicle based on the image captured by the imaging unit 2. In this way, the control unit 13 estimates the traveling state of the other vehicle based on at least one of a result of detection from an on board sensor (the sensor unit 4) that is mounted in the vehicle and detects a nearby object state of the vehicle 1 and the image captured by the imaging unit 2.

Then, the control unit 13 evaluates a driving risk level of the other vehicle based on the estimated traveling state of the other vehicle (Step S13). The control unit 13 evaluates a driving risk level, for example, based on a relative relationship between the estimated traveling state of the other vehicle and the traveling state of the vehicle 1 (hereinafter also referred to as a “host vehicle”) in which the information processing device 10 is mounted. For example, the control unit 13 can acquire various traveling states of the host vehicle such as a speed, a position, a braking frequency, and an amount of operation of an accelerator of the host vehicle from various sensors which are mounted in the vehicle 1. The control unit 13 may acquire the speed of the host vehicle from a result of measurement of the position of the host vehicle by the positioning unit 3. That is, the control unit 13 may calculate a distance between a position of the host vehicle at a certain time point (t0) and a position of the host vehicle at another time point (t1) and calculate the speed of the host vehicle by dividing the calculated distance by (t1−t0).

For example, when acceleration or deceleration (for example, an amount of operation of an accelerator) of the host vehicle is within a predetermined range and a distance between the host vehicle and the other vehicle increases or decreases a predetermined value or more, the control unit 13 determines that driving is performed in a dangerous manner. When the acceleration or deceleration of the host vehicle is constant, the host vehicle is considered to be traveling at a substantially constant speed. When the host vehicle is traveling at a substantially constant speed but the distance between the host vehicle and the other vehicle increases or decreases a predetermined value, the other vehicle is considered to be driven in a dangerous manner such as sudden acceleration or sudden deceleration. Accordingly, the control unit 13 determines that the other vehicle is driven in a dangerous manner.

For example, when an amount of operation of a steering wheel of the host vehicle is within a predetermined range and a change in position in the lateral direction of the other vehicle relative to the host vehicle is equal to or greater than a predetermined value, the control unit 13 determines that driving is performed in a dangerous manner. When the amount of operation of a steering wheel of the host vehicle is within a predetermined range, that the host vehicle is considered not to meander but to travel substantially straightly. When the host vehicle travels straightly and a change in position in the lateral direction of the other vehicle relative to the host vehicle is equal to or greater than a predetermined value, the other vehicle is considered to be driven in a dangerous manner such as sudden steering. Accordingly, the control unit 13 determines that the other vehicle is driven in a dangerous manner.

The control unit 13 identifies a road on which the host vehicle travels, for example, based on the position of the host vehicle measured by the positioning unit 3, and determines that the other vehicle is driven in a dangerous manner when the speed of the other vehicle is higher than a maximum speed of the road. Information on a road and a maximum speed of the road can be stored, for example, in the storage unit 12 in advance.

For example, when the other vehicle is estimated to have performed violation of a traffic signal, violation of temporary stop, traveling over a plurality of lanes, and the like from an image captured by the imaging unit 2, the control unit 13 determines that the other vehicle is driven in a dangerous manner. In this way, the control unit 13 may evaluate a driving risk level of the other vehicle based on a traveling state of the other vehicle estimated from an image captured by the imaging unit 2.

The above-mentioned evaluation of a driving risk level is only an example and the control unit 13 may evaluate a driving risk level of the other vehicle using various methods. In the above-mentioned example, the control unit 13 determines whether the other vehicle is driven in a dangerous manner as a driving risk level, but the evaluation of a driving risk level is not limited thereto. The control unit 13 may evaluate a driving risk level step by step, for example, based on a magnitude of a speed excess by which the speed of the other vehicle excesses a maximum speed on a road on which the other vehicle travels.

Then, the control unit 13 causes the communication unit 11 to transmit dangerous vehicle information including vehicle identification information and a driving risk level of the other vehicle to the database 30 via the network 20 (Step S14) and ends the process routine.

In this embodiment, the information processing device 10 acquires vehicle identification information of the other vehicle from an image captured by the imaging unit 2 which is provided in the vehicle 1 and evaluates a driving risk level of the other vehicle based on a traveling state of the other vehicle. Then, the information processing device 10 stores the dangerous vehicle information including the vehicle identification information and the driving risk level of the other vehicle in the database 30. Accordingly, it is possible to acquire information on a dangerous vehicle in various places in which the vehicle 1 travels, that is, in a broader area as well as a specific place in which a camera is provided as in the related art.

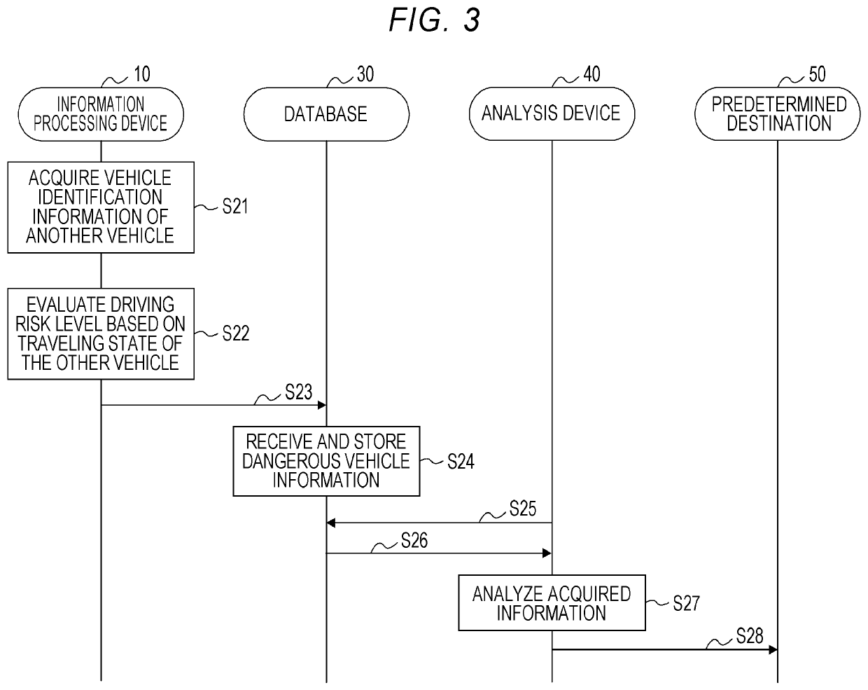

FIG. 3 is a sequence diagram illustrating an example of the operation of the information processing system 100 illustrated in FIG. 1.

The information processing device 10 acquires vehicle identification information of the other vehicle included in an image captured by the imaging unit 2 (Step S21). Then, the information processing device 10 estimates a traveling state of the other vehicle and evaluates a driving risk level of the other vehicle based on the estimated traveling state (Step S22). Then, the information processing device 10 transmits dangerous vehicle information including the vehicle identification information and the driving risk level of the other vehicle to the database 30 (Step S23). The information processing device 10 may add position information of the host vehicle to the dangerous vehicle information.

The database 30 receives and stores the dangerous vehicle information which is transmitted from the information processing device 10 (Step S24).

The analysis device 40 accesses the database 30 (Step S25) and acquires the dangerous vehicle information stored in the database 30 (Step S26). Then, the analysis device 40 analyzes the acquired information (Step S27).

For example, the analysis device 40 identifies a dangerous vehicle based on the acquired dangerous vehicle information. Then, the analysis device 40 transmits information on the identified dangerous vehicle to a predetermined destination 50 (Step S28). The predetermined destination 50 is, for example, a predetermined organization that executes traffic enforcement. The predetermined destination 50 is, for example, the other vehicle in a predetermined area. Here, when position information (position information of the vehicle 1 which has transmitted the dangerous vehicle information) is included in the dangerous vehicle information, the analysis device 40 may estimate a traveling direction of the dangerous vehicle based on the position information. When a dangerous vehicle is included in an imaging range of the imaging unit 2 of the vehicle 1, the position of the dangerous vehicle can be estimated to be substantially the same as the position of the vehicle 1. Accordingly, the analysis device 40 can estimate the traveling direction of the dangerous vehicle from the position information included in the dangerous vehicle information from a plurality of vehicles 1. In this case, the analysis device 40 may transmit information on the dangerous vehicle to vehicles which are in the estimated traveling direction of the dangerous vehicle as the predetermined destination. Accordingly, it is possible to call attention of vehicles which are in the direction in which there is a likelihood that the dangerous vehicle will travel to the dangerous vehicle.

In this way, in this embodiment, the information processing device 10 includes the control unit 13 that acquires vehicle identification information for identifying the other vehicle included in a surrounding image of the vehicle 1 captured by the imaging unit 2 based on the surrounding image and evaluates a driving risk level of the other vehicle based on a traveling state of the other vehicle and the communication unit 11 that transmits dangerous vehicle information including the vehicle identification information and the driving risk level of the other vehicle to the database 30 outside the vehicle 1.

By acquiring vehicle identification information of the other vehicle from an image captured by the imaging unit 2 of the vehicle 1, evaluating a driving risk level of the other vehicle based on a traveling state of the other vehicle, and transmitting dangerous vehicle information including the vehicle identification information and the driving risk level of the other vehicle to the database 30, it is possible to acquire information on a dangerous vehicle in various places in which the vehicle 1 travels, that is, in a broader area as well as a specific place in which a camera is provided as in the related art.

While the information processing device 10 has been described above, a computer may be used to serve as the information processing device 10. Such a computer can be realized by storing a program in which process details for embodying the functions of the information processing device 10 are described in a storage unit of the computer and causing a central processing unit (CPU) of the computer to read and execute the program.

The program may be recorded on a recording medium which is readable by a computer. The program can be installed in a computer using such a recording medium. Here, the recording medium in which the program is recorded may be a non-transitory recording medium. The non-transitory recording medium is not particularly limited and may be, for example, a recording medium such as a CD-ROM or a DVD-ROM.

The above-mentioned embodiment has been described as a representative example, and it is apparent to those skilled in the art that the embodiment can be subjected to various modifications and replacements without departing from the gist and scope of the present disclosure. Accordingly, the present disclosure should not be understood to be limited to the above-mentioned embodiment, and can be subjected to various modifications and changes without departing from the scope of the claims. For example, a plurality of constituent blocks described in the configuration diagram of the embodiment may be combined into a single block, or a single block may be divided into a plurality of blocks.

What is claimed is:

1. An information processing device that is mounted in a vehicle including an imaging unit, the information processing device comprising:
a control unit configured to acquire vehicle identification information for identifying another vehicle included in a surrounding image of the vehicle which is captured by the imaging unit based on the surrounding image and to evaluate a driving risk level of the other vehicle based on a traveling state of the other vehicle; and
a communication unit configured to transmit dangerous vehicle information including the vehicle identification information and the driving risk level of the other vehicle to a database outside the vehicle.

2. The information processing device according to claim 1, wherein the control unit is configured to estimate the traveling state of the other vehicle based on at least one of a result of detection from an onboard sensor that is mounted in the vehicle and detects an object state around the vehicle and the image captured by the imaging unit.

3. The information processing device according to claim 1, wherein the control unit is configured to evaluate a driving risk level of the other vehicle based on a relative relationship between a traveling state of the vehicle and the traveling state of the other vehicle.

4. The information processing device according to claim 1, wherein the control unit is configured to acquire information on at least one of a number, a model, a color, and a type of the other vehicle as the vehicle identification information.

5. The information processing device according to claim 1, wherein the control unit is configured to add position information of the vehicle to the dangerous vehicle information.

6. An information processing system comprising:
an information processing device that is mounted in a vehicle including an imaging unit;
a database that is located outside the vehicle; and
an analysis device,
wherein the information processing device acquires vehicle identification information for identifying another vehicle included in a surrounding image of the vehicle which is captured by the imaging unit based on the surrounding image, evaluates a driving risk level of the other vehicle based on a traveling state of the other vehicle, and transmits dangerous vehicle information including the vehicle identification information and the driving risk level of the other vehicle to the database, and
wherein the analysis device identifies a dangerous vehicle which is driven in a dangerous manner based on the dangerous vehicle information stored in the database and transmits information on the identified dangerous vehicle to a predetermined destination.

7. An information processing method which is performed by an information processing device that is mounted in a vehicle including an imaging unit, the information processing method comprising:
a step of acquiring vehicle identification information for identifying another vehicle included in a surrounding image of the vehicle which is captured by the imaging unit based on the surrounding image and evaluating a driving risk level of the other vehicle based on a traveling state of the other vehicle; and
a step of transmitting dangerous vehicle information including the vehicle identification information and the driving risk level of the other vehicle to a database outside the vehicle.

8. A program causing an information processing device that is mounted in a vehicle including an imaging unit to perform:
a step of acquiring vehicle identification information for identifying another vehicle included in a surrounding image of the vehicle which is captured by the imaging unit based on the surrounding image and evaluating a driving risk level of the other vehicle based on a traveling state of the other vehicle; and
a step of transmitting dangerous vehicle information including the vehicle identification information and the driving risk level of the other vehicle to a database outside the vehicle.
